(19) United States
(12) Patent Application Publication
(10) Pub. No.: US 2015/0017478 A1
(43) Pub. Date: Jan. 15, 2015

(54) METHOD OF SURFACE TREATMENT ON METAL OBJECT AND METAL OBJECT WITH GRADUAL PATTERNS

(71) Applicant: CHIU-HSIANG TSAI, Taichung (TW)

(72) Inventor: CHIU-HSIANG TSAI, Taichung (TW)

(21) Appl. No.: 13/940,279

(22) Filed: Jul. 12, 2013

(51) Int. Cl. B24B 17/02; B44C 1/22

(52) U.S. Cl. CPC B24B 17/023; B44C 1/222
USPC 428/687; 451/29

(57) ABSTRACT

A method of surface treatment on the surface of a metal object includes a step of preparing multiple releasing sheets, each releasing sheet having at least one hollowed pattern; a step of attaching the releasing sheet on the metal object and the hollow patterns of the releasing sheets forming a figure; a step of grinding the surface of the metal object, the sandwheel removing material on the surface of the metal object via the hollowed pattern; a step of moving the releasing sheet, and a step of repeating the steps 2 to 4. The releasing sheet attached to the surface of the metal object of each of the repeated steps is different from the previous one. The sandwheels for grinding the metal object corresponding to the different releasing sheets have different roughness to obtain the figure. The metal object has an obvious figure and does not pollute the environment.

### FIELD OF THE INVENTION

The present invention relates to a method of surface treatment on the surface of metal objects without pollution, and a metal object having gradual patterns formed on the surface thereof.

### BACKGROUND OF THE INVENTION

As shown in FIG. 9, the conventional way to form patterns on the surface of a metal object 30 is to use method of laser engraving or transferring printing to form at least one pattern 32 on the surface 31 of the metal object 30 which can be a metal tube, a metal block or a metal plate. The at least one pattern 32 may include patterns, characters, or figures the combination of the mentioned factors, the at least one patter 32 can be used as a trademark, specification and other decoration purposes.

However, the method of laser engraving has higher manufacturing cost which damages the competition in the market. If the patterns to be made are in large size, it takes a lot of time and the economic benefit will be reduced. Therefore, the method of laser engraving is usually used for smaller metal objects. The method of transferring printing is less expensive than the method of laser engraving, and the efficiency is higher than the method of laser engraving, but it uses a chemical layer attached on the surface 31 of the metal object 30 so as to form the desired patterns 32. The patterns 32 are easily removed from the metal object 30 and the chemical layer attached on the surface 31 of the metal object 30 may cause pollution to the environment.

The present invention intends to provide a method of surface treatment on the surface of metal objects without pollution, and a metal object having gradual patterns formed on the surface thereof.

### SUMMARY OF THE INVENTION

The present invention relates to a method of surface treatment on the surface of a metal objects and comprises the following steps:

step 1: preparing multiple releasing sheets: each releasing sheet has at least one hollowed pattern and all of the hollow patterns of the releasing sheets form a figure;

step 2: attaching the releasing sheet 20: attaching one releasing sheet on the surface of the metal object which is a metal tube, a metal object, a metal plate or a bicycle frame;

step 3: surface grinding: using a sandwheel to grind the surface of the metal object on which the releasing sheet is attached, the sandwheel removing material on the surface of the metal object via the hollowed pattern so as to form a treated surface which is shaped the same as the hollow pattern;

step 4: moving the releasing sheet, and step 5: repeating the steps 2 to 4: the releasing sheet being attached to the surface of the metal object of each of the repeated steps being different from the previous one, the sandwheels for grinding the surface of the metal object corresponding to the different releasing sheets having different roughness so as to obtain multiple treatment faces of different smoothness, the multiple treatment faces forming the figure.

Alternatively, the present invention provides a metal object and comprises multiple treatment faces formed on the surface of the metal object. The treatment faces are made by using multiple sandwheels with different roughness. The multiple treatment faces have different smoothness. The treatment faces form at least one figure.

The primary object of the present invention is to provide a method for making a figure on the surface of a metal object by using sandwheels of different roughness to make multiple treatment faces which form a figure. The figure is made by directly grinding the metal object by sandwheels so that the method does not pollute the environment. The figures are formed by cooperation of different releasing sheets wherein each of the releasing sheets has a specific hollowed pattern and the sandwheels grind the material of the metal object via the hollowed patterns. The method has low manufacturing cost and is easily operated. The figure is visualized to have gradual effect.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the method of the present invention;

FIG. 2 shows the metal object treated by the method of the present invention;

FIG. 3 shows the figures on the metal object treated by the method of the present invention;

FIG. 4 shows the first treatment faces and the second treatment faces on the metal object treated by the method of the present invention;

FIG. 5 shows the third treatment faces are added on the metal object shown in FIG. 4;

FIG. 6 shows the second embodiment of the figure made by the method of the present invention;

FIG. 7 shows the third embodiment of the figure made by the method of the present invention;

FIG. 8 shows the fourth embodiment of the figure made by the method of the present invention, and

FIG. 9 shows the conventional metal tube with figure on the surface thereof.

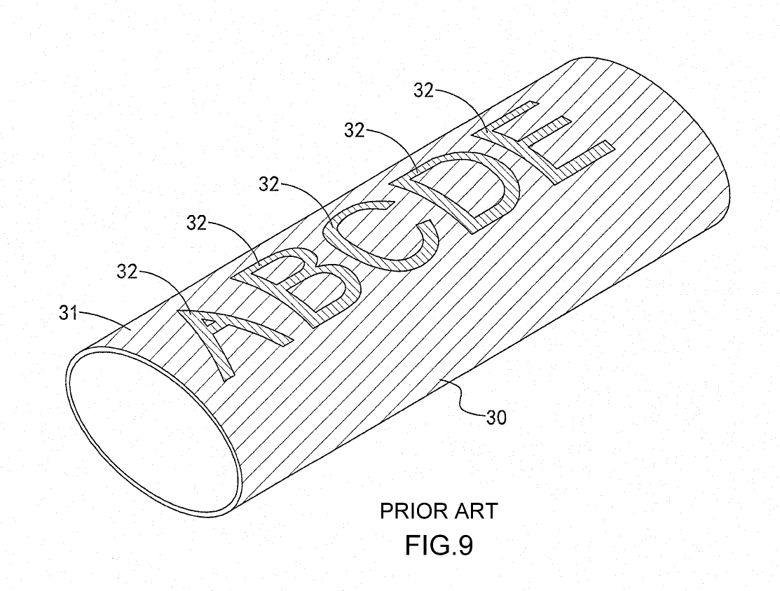

### DETAILED DESCRIPTION OF THE PREFERRED EMBODIMENT

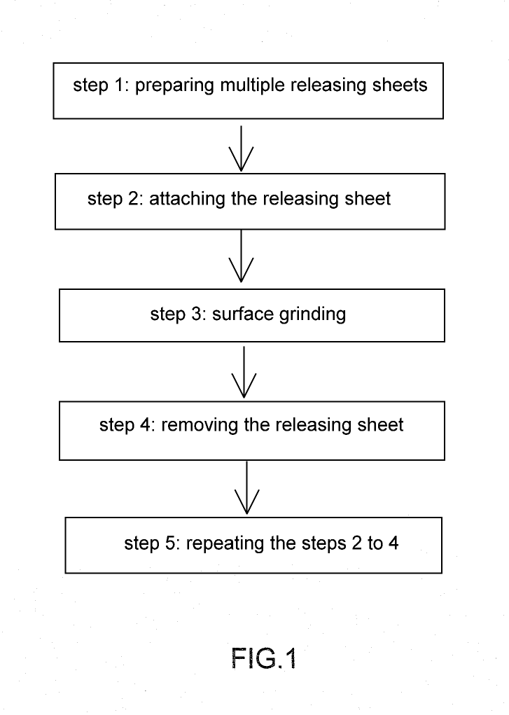

Referring to FIG. 1, the method of surface treatment on the surface of a metal object of the present invention is disclosed, the metal object 10 is a metal tube, a metal object, a metal plate or a bicycle frame. The method of the present invention comprises the following steps:

step 1: preparing multiple releasing sheets. Each releasing sheet at least one hollowed pattern, the hollow patterns of all of the releasing sheets form a figure.

step 2: attaching the releasing sheet. The releasing sheet is attached on the surface of the metal object.

step 3: surface grinding. A sandwheel is used to grind the surface of the metal object on which the releasing sheet is attached. The sandwheel removes material on the surface of the metal object via the hollowed pattern so as to form a treatment face which is shaped the same as the hollow pattern.

step 4: removing the releasing sheet.

step 5: repeating the steps 2 to 4 at least one time. The releasing sheet attached to the surface of the metal object of each of the repeated steps 2 is different from the previous one. The sandwheels for grinding the surface of the metal object corresponding to the different releasing sheets have different roughness so as to obtain multiple treatment faces of different smoothness. The multiple treatment faces form the figure which is distinguishable.

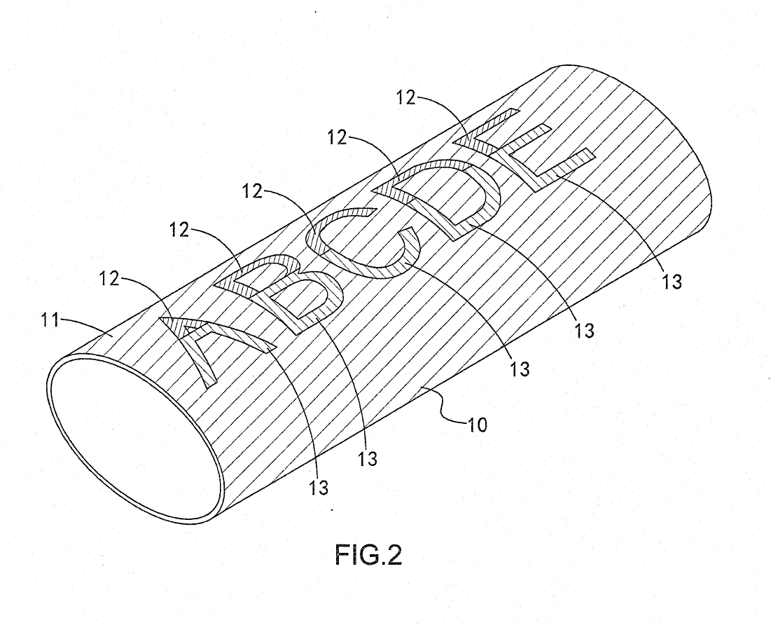

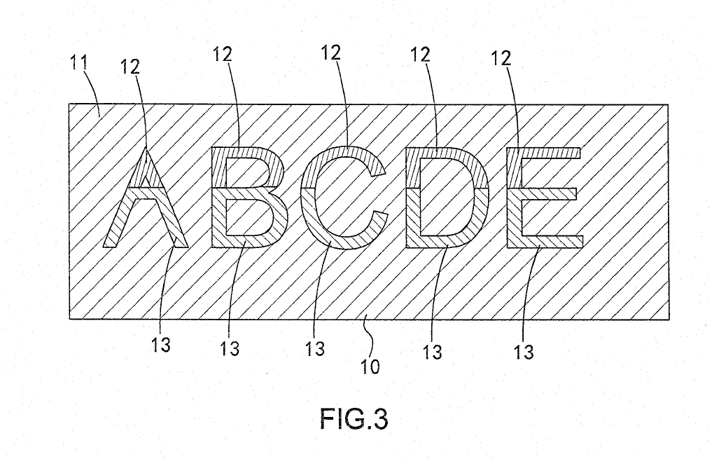

As shown in FIGS. 2 and 3, the metal object 10 includes multiple treatment faces 11, 12, 13 formed on the surface of the metal object 10, and the multiple treatment faces 11, 12, 13 are made by using different sandwheels with different roughness to grind the surface of the metal object 10. The multiple treatment faces 11, 12, 13 have different smoothness to form the figure such as the “ABCDE” as shown. The figure composed of the treatment faces 11, 12, 13 comprises one of patterns and characters, or a combination of the patterns and the characters.

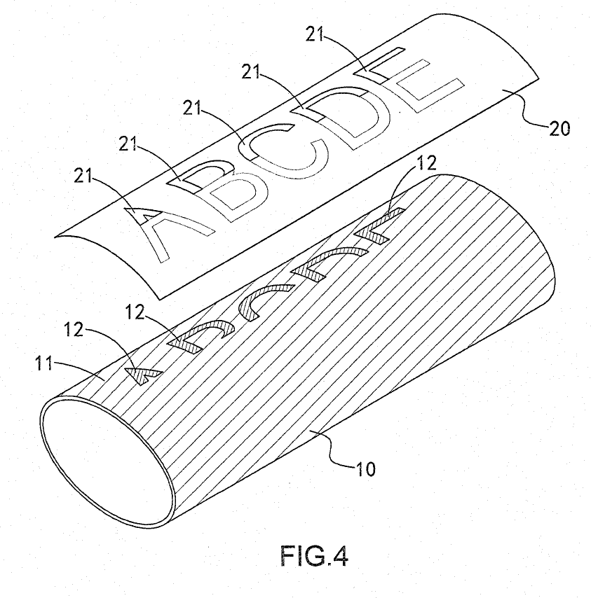

As shown in FIG. 4, the surface of the metal object 10 is ground to have the first treatment faces 11 by a first sandwheel which has a first roughness. The first treatment faces 11 are formed on the whole surface of the metal object 10. A first releasing sheet 20 is then attached on the surface of the metal object 10. The first releasing sheet 20 is made by wear-resistant material and has multiple first hollow patters 21. A second sandwheel is used to grind the metal object 10 and portions that are exposed from the first hollow patterns 21 are ground so as to form a second treatment faces when the first releasing sheet 20 is removed from the metal object 10. The metal object 10 is a metal tube, a metal object, a metal plate or a bicycle frame.

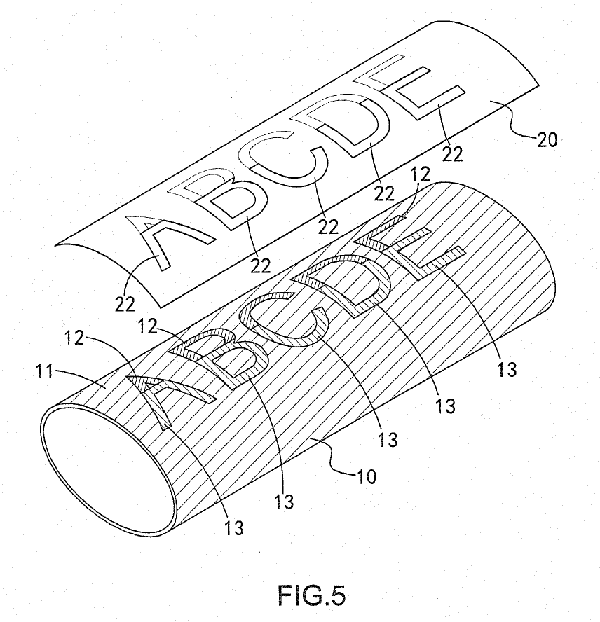

As shown in FIG. 5, a second releasing sheet 20 is then attached on the surface of the metal object 10, the second releasing sheet 20 has multiple second hollow patters 22. A third sandwheel is used to grind the metal object 10 and portions that are exposed from the second hollow patterns 22 are ground so as to form third treatment faces 13 when the second releasing sheet 20 is removed from the metal object 10. The third sandwheel has a roughness different from the previous sandwheels. The second and third treatment faces 12, 13 have different positions and shapes so that a figure is formed by the second and third treatment faces 12, 13 on the first treatment faces 11 which are used as the background. The first treatment faces 11, the second treatment faces 12 and the third treatment faces 13 have different smoothness due to different sandwheels, the figure formed by the second and third treatment faces 12, 13 is visualized to have two layers of gradual effect on the first treatment faces 11. The smoothness of the first treatment faces 11 has the most rough surfaces, and the second treatment faces 12 have the mediate roughness and form the upper parts of the figure “ABCDE”, and the third treatment faces 13 have the finest surfaces and form the lower parts of the figure “ABCDE”. By the different smoothness of the second and third treatment faces 12, 13, the figure is visualized to have two layers of gradual effect on the first treatment faces 11.

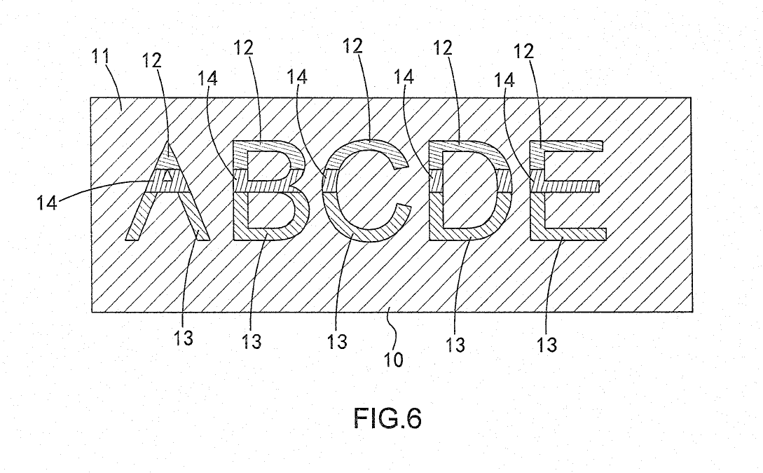

As shown in FIG. 6 which shows the second embodiment of the metal object made by the method of the present invention, wherein three releasing sheets 20 with different hollow patterns, and four shandwheels with different roughness are used. The metal object 10 has first, second, third and fourth treatment faces 11, 12, 13, 14 with different smoothness formed thereon. The figure “ABCDE” is composed by the second, third and fourth treatment faces 12, 13, 14, so that the figure is visualized to have three layers of gradual effect on the first treatment faces 11. It is noted that when using more releasing sheets and more sandwheels, the figure formed will have more layers of gradual effect on the first treatment faces 11.

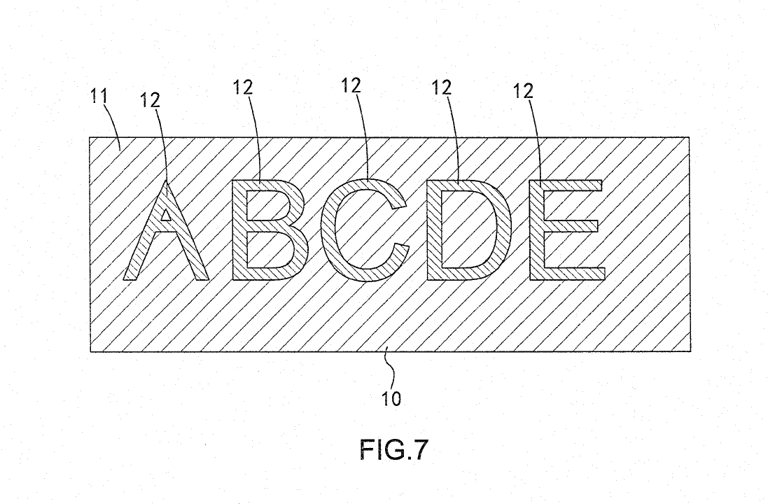

As shown in FIG. 7 which shows the third embodiment of the metal object made by the method of the present invention, wherein the whole surface of the metal object 10 is ground to have first treatment faces 11 by the first sandwheel with the first roughness. A releasing sheet 20 (not shown) with hollow patterns is attached on the metal object 10. A second shandwheel with different roughness is used to ground the metal object 10, when the releasing sheet is removed, multiple second treatment faces 12 are formed which shows the figure “ABCDE”.

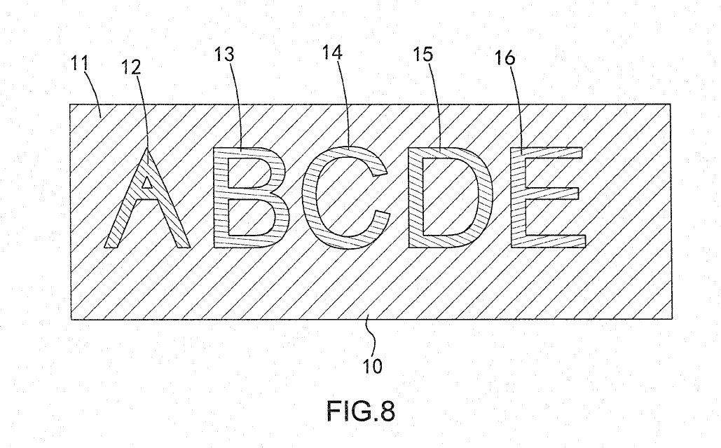

As shown in FIG. 8 which shows the fourth embodiment of the metal object made by the method of the present invention, wherein the whole surface of the metal object 10 is ground to have first treatment faces 11 by the first sandwheel with the first roughness. A releasing sheet 20 with the hollow patterns “A” is attached on the metal object 10. A second shandwheel with different roughness is used to ground the metal object 10, when the releasing sheet is removed, multiple second treatment faces 12 are formed which shows the figure “A”. A releasing sheet 20 with the hollow patterns “B” is attached on the metal object 10. A third shandwheel with different roughness is used to ground the metal object 10, when the releasing sheet is removed, multiple third treatment faces 13 are formed which shows the figure “B”. By repeating the steps, the figures “C”, “D” and “E” made by the fourth, the fifth and the sixth treatment faces 14, 15, 16 are formed.

The present invention has the following advantages:

By using sandwheels of different roughness to grind the surface of the metal object to have multiple treatment faces, these treatment faces form a figure which is distinguisable and can be used as decoration.

The figure is made by directly grinding the metal object by sandwheels so that the method does not pollute the environment.

The figures are formed by cooperation of different releasing sheets wherein each of the releasing sheets has a specific hollowed pattern and the sandwheels grind the material of the metal object via the hollowed patterns. The method has low manufacturing cost and is easily operated.

The figure is visualized to have gradual effect.

While we have shown and described the embodiment in accordance with the present invention, it should be clear to those skilled in the art that further embodiments may be made without departing from the scope of the present invention.

What is claimed is:

1. A method of surface treatment on surface of metal objects, comprising the following steps:
step 1: preparing multiple releasing sheets: each releasing sheet having at least one hollowed pattern, the hollow patterns of all of the releasing sheets forming a figure;
step 2: attaching the releasing sheet 20: attaching one releasing sheet on a surface of a metal object which is a metal tube, a metal object, a metal plate or a bicycle frame;
step 3: surface grinding: using a sandwheel to grind the surface of the metal object on which the releasing sheet is attached, the sandwheel removing material on the surface of the metal object via the hollowed pattern so as to form a treatment face which is shaped the same as the hollow pattern;
step 4: removing the releasing sheet, and
step 5: repeating the steps 2 to 4: the releasing sheet being attached to the surface of the metal object of each of the repeated steps 2 being different from the previous one, the sandwheels for grinding the surface of the metal object corresponding to the different releasing sheets having different roughness so as to obtain multiple treatment faces of different smoothness, the multiple treatment faces forming the figure;
the surface of the metal object being ground by a sandwheel with different roughness from those of the sandwheels in steps 3 to 5 before the first releasing sheet is attached to the metal object to form multiple first treatment faces on the surface of the metal object, the first treatment faces having different smoothness to make the figure to have gradual effect visually.

2. The method as claimed in claim 1, wherein the figure composed of the treatment faces comprises one of patterns and characters, or a combination of the patterns and the characters.

3. The method as claimed in claim 1, wherein the surface of the metal object is ground to have first treatment faces by a first sandwheel which has a first roughness, a first releasing sheet is then attached on the surface of the metal object, the first releasing sheet is made by wear-resistant material and has multiple first hollow patters, a second sandwheel is used to grind the metal object and portions that are exposed from the first hollow patterns are ground so as to form second treatment faces when the first releasing sheet is removed from the metal object, a second releasing sheet is then attached on the surface of the metal object, the second releasing sheet has multiple second hollow patters, a third sandwheel is used to grind the metal object and portions that are exposed from the second hollow patterns are ground so as to form third treatment faces when the second releasing sheet is removed from the metal object, the second and third treatment faces have different positions and shapes so that a figure is formed by the second and third treatment faces, the first treatment faces, the second treatment faces and the third treatment faces have different smoothness due to different sandwheels, the figure formed by the second and third treatment faces is visualized to have two layers of gradual effect on the first treatment faces.

4. The method as claimed in claim 3, wherein the three respective smoothness of the first treatment faces, the second treatment faces and the third treatment faces are changed from rough to fine.

5. The method as claimed in claim 1, wherein the metal object has three releasing sheets with different hollowed patterns attached thereon and the metal object is ground by four sandwheels with different roughness so as to form first treatment faces, second treatment faces, third treatment faces and fourth treatment faces, the second, third and fourth treatment faces form a figure which is visualized to have three layers of gradual effect on the first treatment faces.

6. A metal object comprising:
multiple treatment faces formed on a surface of the metal object, the treatment faces being made by using multiple sandwheels with different roughness, the multiple treatment faces having different smoothness, the treatment faces forming at least one figure which is visualized to have gradual effect.

7. The metal object as claimed in claim 6, wherein the at least one figure composed of the treatment faces comprises one of patterns and characters, or a combination of the patterns and the characters.

8. The metal object as claimed in claim 6, wherein the metal object has multiple figures formed on the surface thereof, each figure has the same type of treatment faces of a specific smoothness.

9. The metal object as claimed in claim 6, wherein the metal object has multiple figures formed on the surface thereof, each of the figures has the same type of treatment faces and all of the treatment faces have the same smoothness, the rest part of the surface of the metal object have different smoothness from that of the figures.

10. The metal object as claimed in claim 6, wherein the surface of the metal object has first treatment faces, second treatment faces and third treatment faces, the first treatment faces are formed along the whole surface of the metal object, the second and third treatment faces form a figure, the first treatment faces, the second treatment faces and the third treatment faces are made by the sandwheels of different roughness so as to have different smoothness, the figure formed by the second and third treatment faces is visualized to have two layers of gradual effect on the first treatment faces.

11. The metal object as claimed in claim 10, wherein the three respective smoothness of the first treatment faces, the second treatment faces and the third treatment faces are changed from rough to fine.

12. The metal object as claimed in claim 6, wherein the surface of the metal object is grounded by four sandwheels with four different roughness to have the first treatment faces, the second treatment faces, the third treatment faces and the fourth treatment faces, the first treatment faces, the second treatment faces, the third treatment faces and the fourth treatment faces have different smoothness, the figure formed by the second, third and fourth treatment faces is visualized to have three layers of gradual effect on the first treatment faces.
